(19) United States
(12) Patent Application Publication
(10) Pub. No.: US 2004/0186763 A1
(43) Pub. Date: Sep. 23, 2004

(54) System for real-time monitoring and cost management of construction projects

(76) Inventor: Charles Smith, Deer Park, NY (US)

Correspondence Address: Karl F. Milde, Jr., Esq., MILDE & HOFFBERG, L.L.P., 10 Bank Street, Suite 460, White Plains, NY, 10606, US

(21) Appl. No.: 10/392,096

(22) Filed: Mar. 18, 2003

(51) Int. Cl. G06F 17/60

(52) U.S. Cl. 705/9

(57) ABSTRACT

A novel system for the monitoring and management of construction projects; and the addition of electronic communication devises to the system, to provide new opportunities and systems for the monitoring and management of large construction projects and businesses.

### FIELD OF THE INVENTION

The present invention relates to systems for the monitoring and managing of construction projects, and to the combination of electronic communication systems with the monitoring and managing systems.

### BACKGROUND OF THE INVENTION

The coordination and management of construction projects is an ongoing desire. In recent years, real-time, electronic communication devices have been employed by those who oversee construction projects. In addition, construction management programs and services have been offered over the Internet. These services have provided some benefit, but have created burdens for their customers in requiring the integration of the company's existing accounting systems, employee production review process, etc., with the Internet management programs and services.

### SUMMARY OF THE INVENTION

The present invention provides a system for real-time monitoring and cost management of construction projects. The system lays out information in data rich pages, which are interconnected by various navigation routes, permitting different views of the information by various users. The system permits real-time, secured data entry, and access, from multiple devices in various geographic locations. In addition, the system automatically posts proposed change orders and possible time impact and/or cost impact reports until a change order approval is completed. These documents can be made available on a real-time basis to the individuals who must approve the change order. Thus the system allows the users to have greater control over the overall construction project by providing real-time data entry, and electronic transmission change orders and approvals.

The system permits management personnel in the construction company to monitor and manage their individual projects and their total business in new and timely ways, alternately laying open the information for individual projects, multi-project businesses or company sectors, as well as the total business. Clients are also permitted to interact with the system, allowing them the real-time monitoring and cost management of their construction projects.

It is an object of the present invention to provide a single system for monitoring a construction business and/or individual construction projects, which will more quickly highlight construction difficulties in a particular project, or, within the construction company. It is also an object of the present invention to create a system which is compatible with current accounting systems and personnel management systems. It is a further object of the present invention to provide a system which will automatically generate real-time reports which cull together the work load and success of particular project managers, detect excess overtime, or other costs, and organize a particular client=s construction projects for internal review or viewing by the client.

The system may be erected on a computer, website or server, and may be accessed by a variety of electronic communication devices. In one enormous improvement, a system is provided which can do an instant, or real-time, calculation of a proposed change order, instantly generate a possible cost impact and/or schedule impact report, make those reports instantly available to the people responsible for the resolution of the proposed change, and hold the reports on the system until the proposed change order is resolved. For example, the system can contact these individuals and can make these reports available to them on a real-time basis through cell phones, laptops or handheld devices such as PDA=s. Thus the monitoring and management system of the present invention not only provides new systems for managing construction projects, but monitors construction projects in a new way, allowing the participants to develop new management techniques and skills.

These objects, as well as other objects which will become apparent from the discussion that follows, are achieved in accordance with the present invention, which comprises a system for instant, or real-time, monitoring and cost management of a construction project or business, using data entry of time estimates and budget cost estimates selected from the group consisting of: proposal costs, trade budgets, trade schedules of value, base contract markups, job budgets, general conditions budgets, proposed change orders, change orders and change order budgets, change order markups, and internal purchase orders; and real-time data entry of costs incurred, selected from the group consisting of: trade costs, including back charges and allowances, general conditions costs, and-contingency costs; the automatic, real-time calculation of variations in budget estimates and time estimates; and the automatic generation and posting of proposed change orders to reflect the variations in time schedule and budget estimates, and cost impact and/or schedule impact reports.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is an illustration of a AWelcome@ or opening page of the monitoring and management system of the present invention.

FIG. 2 is an illustration of a Project Manager page of the present invention, listing the active jobs by Job Number.

FIG. 3 is an illustration of a Job Master Summary page of the present invention, and illustrating a Base Contract Snapshot, showing a Base Contract Summary and the Base contract Mark-ups.

FIG. 3A is a Job Master Summary page of the present invention, illustrating a Job Snapshot showing Job Profitability and Work Flow.

FIG. 3A1 is an illustration of a Job Master Summary page of the present invention, illustrating a Job Snapshot showing Job Profitability and Accounting.

FIG. 3B is an illustration of a Job Master Summary page of the present invention, illustrating a Change Order Snapshot, showing the Complete Change Order Summary, with Change Order Markups.

FIG. 4 is an illustration of a Options Menu from the Job Master Summary page.

FIG. 5 is an illustration of a Job Markups window reached from the options menu of FIG. 4.

FIG. 6 is an illustration of a Budget Maintenance page reached from the options menu of FIG. 4.

FIG. 7 is an illustration of a Change Order Summary page reached from the options menu of FIG. 4, illustrating a Change Order Snapshot.

FIG. 8 is an illustration of a Change Order Detail page of the present invention.

FIG. 8A is an illustration of a data entry Change Order Detail page of the present invention.

FIG. 9 is an illustration of an Administrative Menu from the Project Manager=s page, showing the maintenance submenu.

FIG. 10 is an illustration of a Reporting Menu from a Project Manager page, illustrating the master lists menu, including the Job Master Summary page and the Client Master Summary page.

FIG. 11 is an illustration of a Job Report Menu FIG. 12 is an illustration of a Client Master File Maintenance page of the present invention.

FIG. 13 illustrates the Job Billing Summary page listing all invoices on the job by application number.

FIG. 13A illustrates an Invoice Maintenance page, AIA View, Base contract only, listing all items in the base contract by cost code and change order.

FIG. 13 A1 illustrates an Invoice Maintenance page in the Purchase Order View for a selected item of FIG. 13A.

FIG. 13B illustrates an Invoice Maintenance page, AIA View, of All Change Orders.

FIG. 13B1 illustrates an Invoice Maintenance page, Purchase Order View of a selected item in FIG. 13B.

FIG. 13C illustrates an Invoice Maintenance page, AIA View, of the budgeted items for a particular Change Order.

FIG. 14 is a diagram of a navigational map from the Job Master Summary page.

FIG. 15 is a diagram of a navigational map from the Project Manager page.

FIG. 16 is a diagram of a navigational map from the Change Order Summary page.

FIG. 17A is an illustration of the view menu from the Project Manager page, showing the Status submenu.

FIG. 17B is an illustration of the view menu from the Project Manager page, showing the Division submenu.

FIG. 18 illustrates a Job Master Summary page showing the Client menu.

FIG. 19 illustrates Enter New Job page for adding to the Job Master Summary listing.

FIG. 20 is an illustration of navigational buttons of the system of the present invention.

### DESCRIPTION OF THE PREFERRED EMBODIMENTS

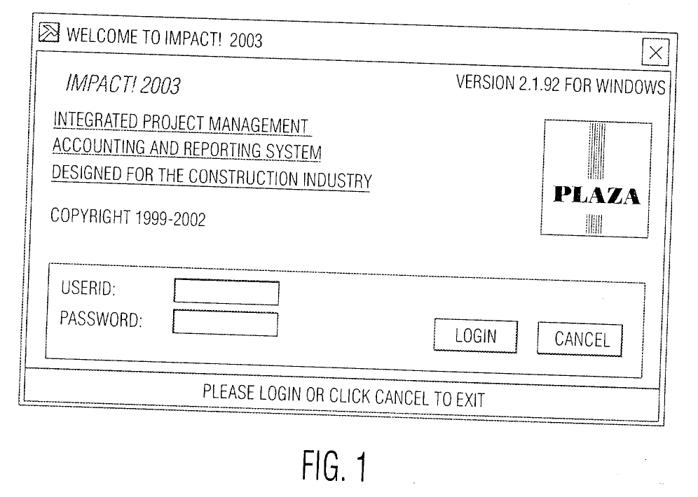

The preferred embodiments of the present invention will now be described with reference to FIGS. 1-20 of the drawings. Identical elements in the various figures are designated with the same reference numerals.

The gathering, calculating, reporting and communication of construction data in the monitoring and management system of the present invention provides information of enormous value. Hence, access to the system, for input, viewing or reporting must be regulated. The “Welcome” page, an example of which is shown in FIG. 1, contains a text box for the Userid and Password, which determines the users access under the current security system. In most instances, the size of the system will require many levels of secured access. For instance, the system may be monitoring the profitability of each overall project, and the total profitability for that project manager, but it may also have further information on multiple construction projects undertaken by a construction company which are not overseen by that project manager.

In addition, clients may view all or part of the information related to the work being done for them. The costs, expenses, profitability, etc., at each level is, and must remain, confidential to the business entity, especially when in a business run on bidding, and/or competitive bidding. The system must maintain security while this profitability data is updated during the construction project, by personnel from different business sectors or entities, with vastly different access levels. For instance, proposed job changes, (in change order form) produce immediate posting of the possible cost and/or schedule impact reports (including allocation or assumption of cost) and the effect on overall profitability. However, data entry from which proposed change orders are generated, and the approvals of change orders, may require input from people in the field, and generation of reports to people in the field. Those inputting the data will not always be those monitoring profitability, and those responsible for inputting data related to a change order may not be permitted to input other data, such as change order approvals. Various client personnel may be allowed to view, enter data relating to, and approve, change orders.

For those who manage a construction company involved in many construction projects, the system will provide information on the success of working with various business entities and/or individuals. The rapid and multi-aspect reporting available in the system will also provide additional opportunities for, e.g., recouping company generated costs, monitoring the success of company personnel, checking for material cost overruns, or overtime billing. Because confidentiality and security are a part of doing business, as the present system is expanded to provide reporting not provided by other systems, it will require establishing new security access levels for the system.

The system may be understood by the tiers, or ranking of the “pages”, and/or the circum-navigational routes offered by, e.g., the “drop down” menus from the menu bar, the navigational buttons, the drop down toggle menus which change only a portion of the page, and the selection (by double clicking) of a an entry on the page, to bring up a page or window which provides greater detail. The system provides an extraordinary amount of information on each page, and numerous ways to move between the pages, providing a system that can be used by many people, for a number of different evaluations. The evaluations are undertaken by tracking the dollar amounts assigned to different aspects of the construction work. While accounting methods may be vary between construction companies, the system may be easily tailored to it, so as to always provide extraordinary amounts of information, and easy to access for a variety of evaluations. In the embodiment of the system described herein, specific dollar amounts are included, to reflect the change in underlying accounting method for each Job Type, and to illustrate the amount of information provided by the system.

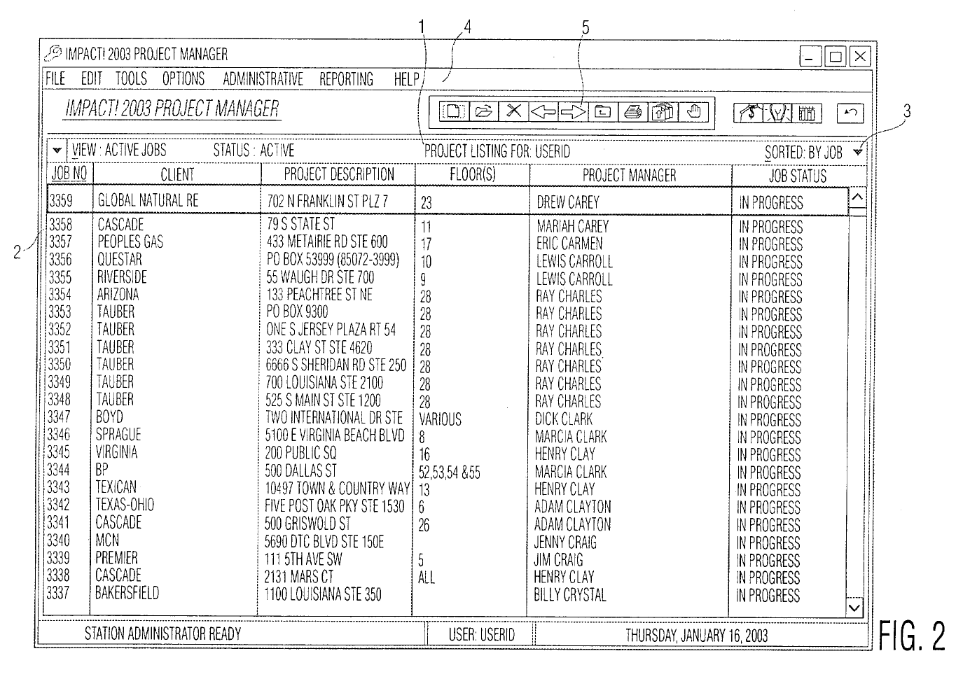

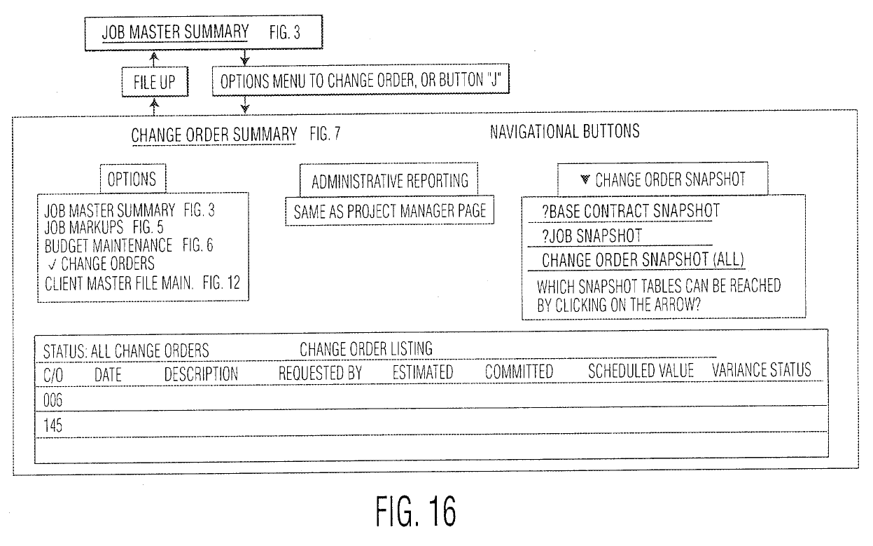

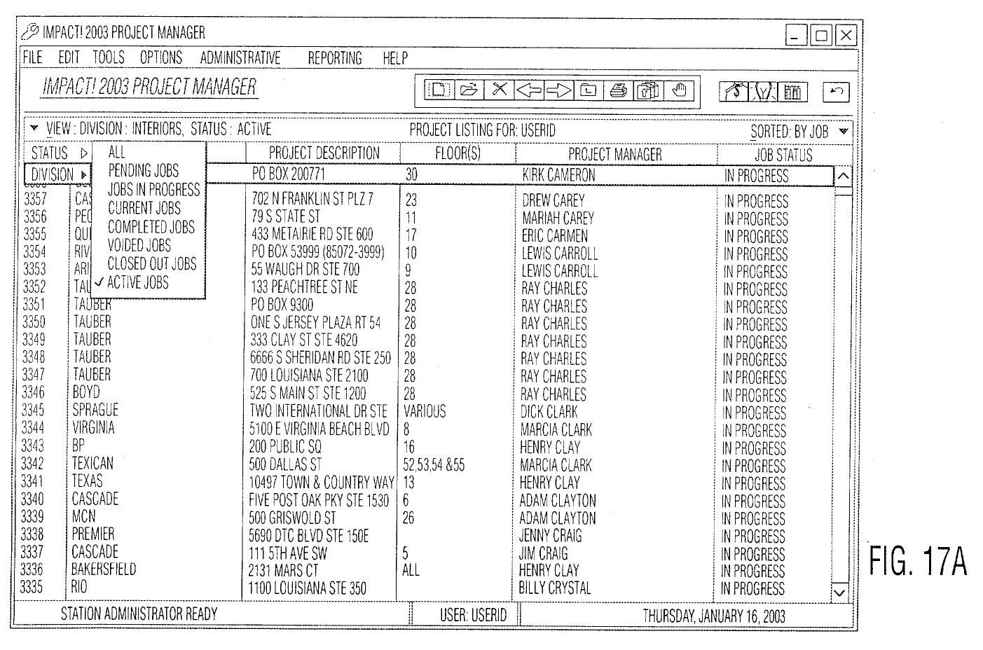

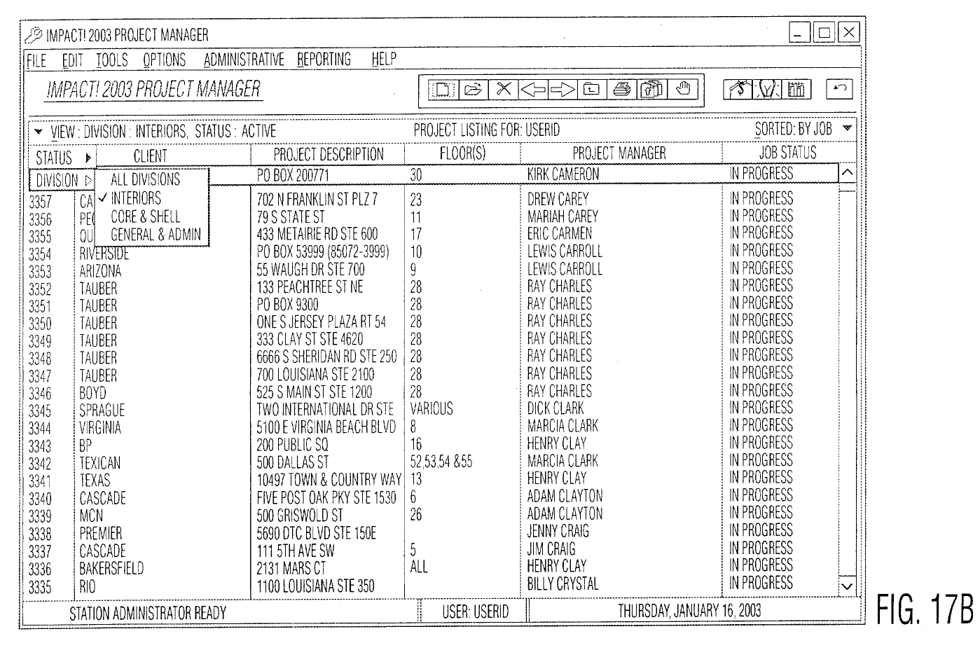

FIG. 2 illustrates the “Project Manager” page. The Project Manager page is the only tier one page. In FIG. 1, the Project Manager page shows a listing, 1, of all active jobs. Most often, Active Jobs means those jobs for which billing (including receipt of invoiced amounts) has not been completed. The Project Listing may provide different views, examples of which are active and inactive jobs, and completed jobs. Different views of the Project listings of the Project Manager page will be described in relation to FIGS. 17A & 17B, below. As may be noted, the active job listing includes a Job Number, 2, commonly assigned in numerical order, and used to track the jobs undertaken. The numerically ordered listing may be sorted and viewed by status; such as Active Jobs, as shown at 3, or broken down into Listings for Jobs Pending or In Progress. Note that the Project Manager listing may be edited by Userid or security level. From the jobs listed on the “Project Manager” page, the user may select an individual job, and, e.g. double click to open, the Job Master Summary page for that job.

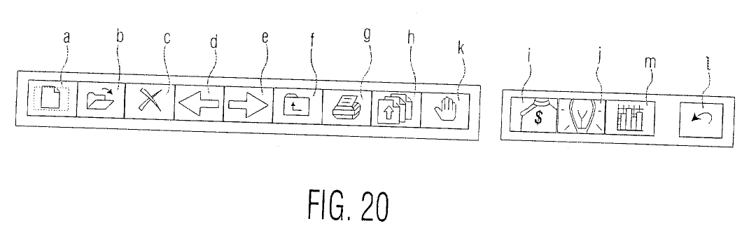

As shown in this Project Manager listing, the Project Description, the floors involved, the Project Manager and Job status are presented in columns, for ease of scrolling through these details of the job listings. Along the top of the Project Manager page is a menu bar, 4, which allows the user to proceed to the pages of other organizational sections of the system, from which the user can find data about the project which emphasize other aspects or details about the job. Bu selecting one of the entries on the menu bar: file, edit, tools, options, administrative, reporting, and help; a drop-down menu presents the navigation opportunities. The Options, Administrative and Reporting “drop down” menus from the Project Manager, Job Master Summary and Change Order Summary and Billing Summary pages are all the same, and navigation opportunities, will be presented separately below. Many of the navigation opportunities are also available through the buttons, 5. These buttons are described in detail in relation to FIG. 20, below.

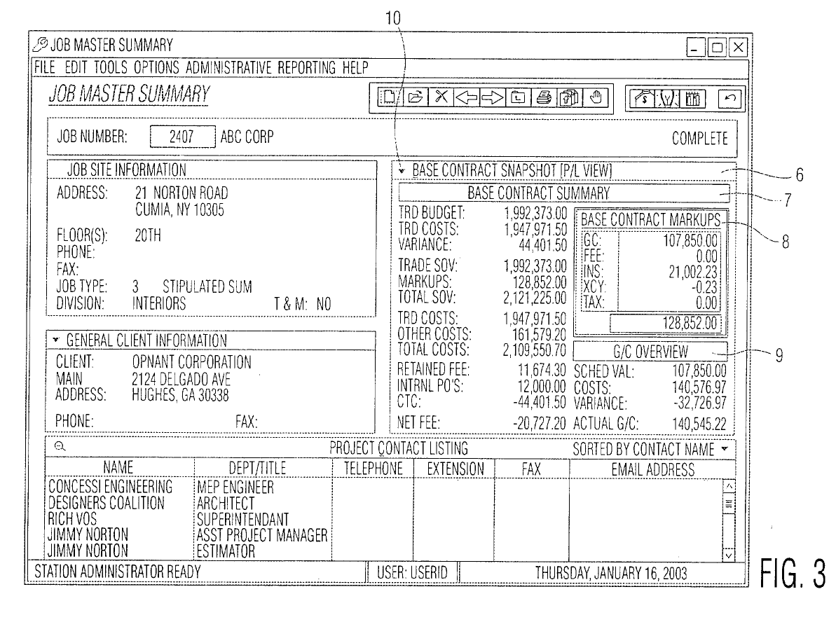

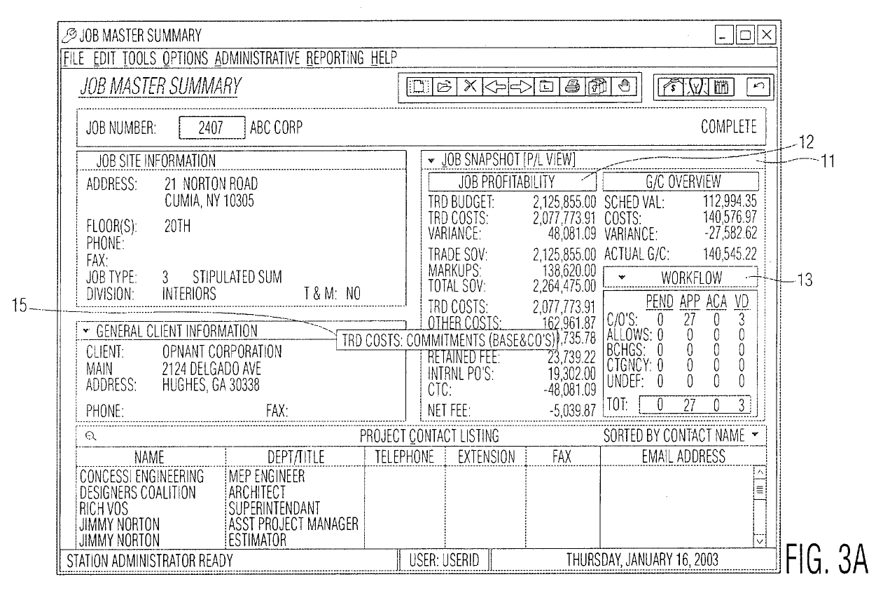

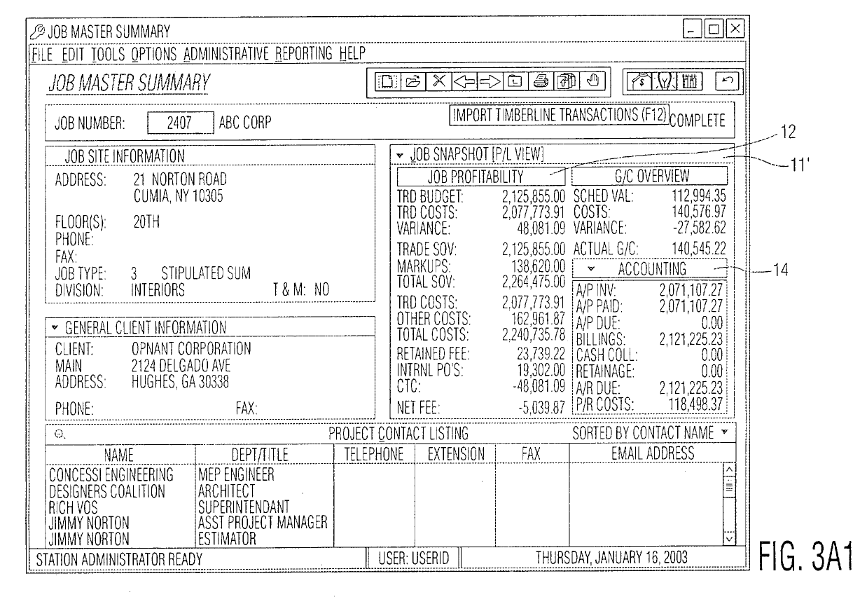

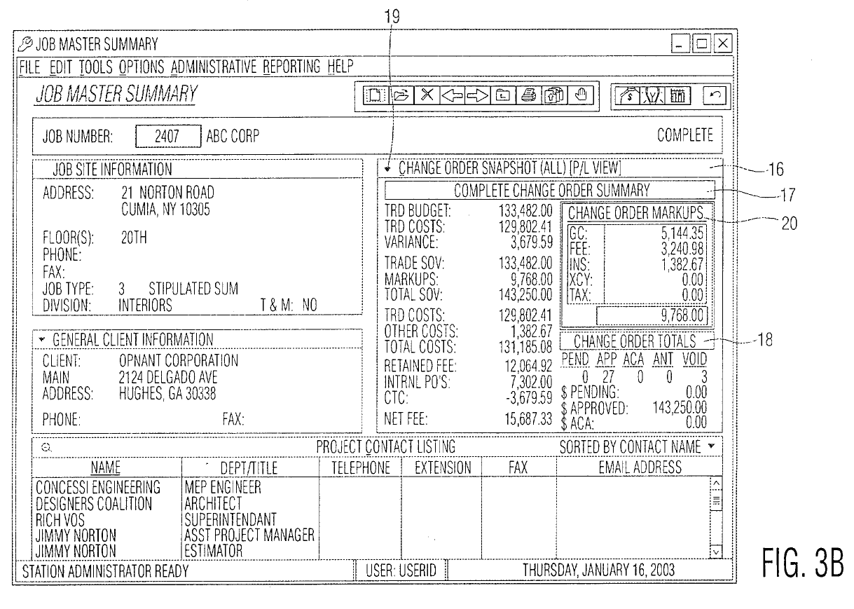

FIG. 3 illustrates the Job Master Summary page which may be reached by selecting a particular Project Listing. Th Job Master Summary is a tier two page. This page gives the details of a particular job. As shown in FIG. 3, this particular job, designated by Job Number 2407, is “COMPLETE”. Navigational buttons are provided, as on the Project Manager page.

The Job Master Summary page has windows for the “Job Site Information”; “General Client Information”; a scrolling window for the Project Contract Listing, giving Contact Name or Dept./Title. The Job Master Summary page also has a Snapshot window. This snapshot window will be described below. Alternate snapshot windows will be described in relation to FIGS. 3A, 3A1 and 3B, below.

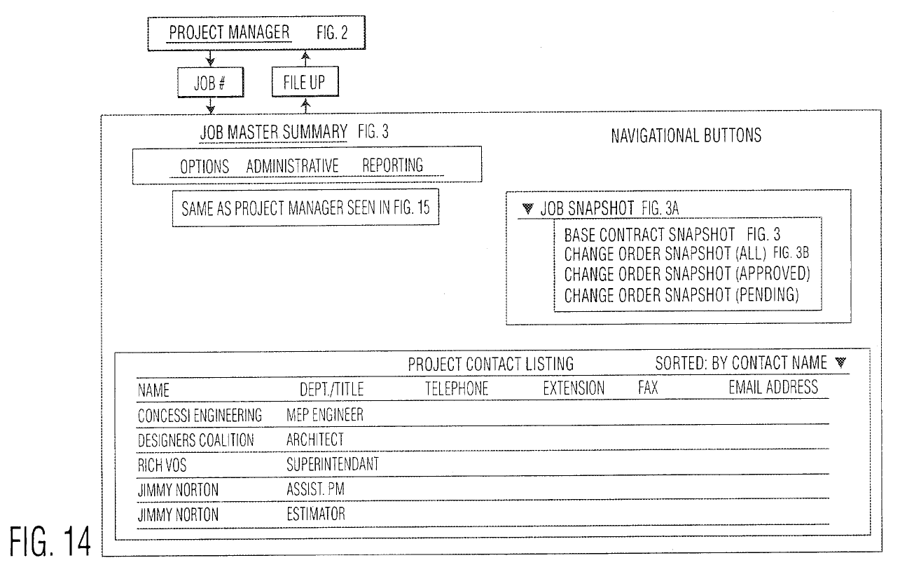

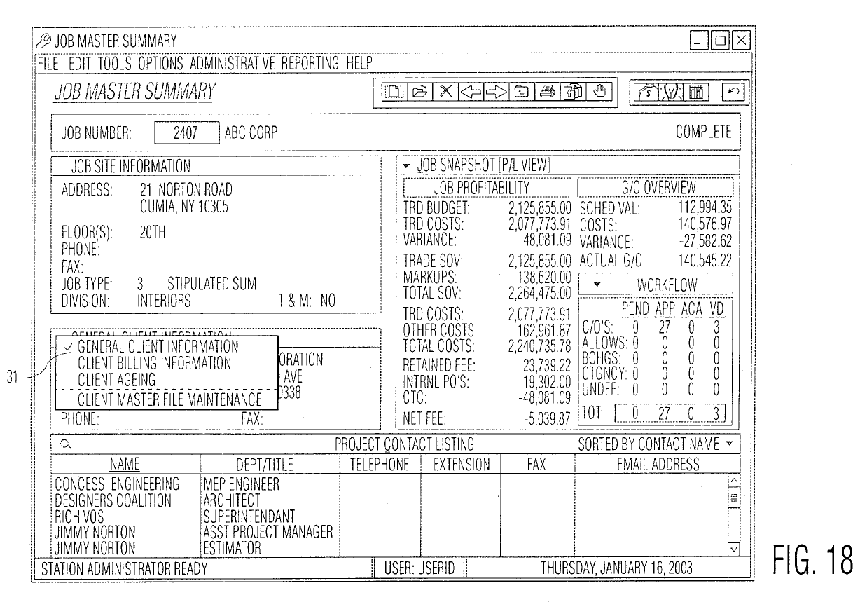

Included in the Job site Information in FIG. 3 is Job Type, and division. Examples of Job Types are 1) Actual Costs which includes Trade Costs and Actual General Conditions Costs, 2) Actual Trade Costs plus General Conditions calculated at a fixed dollar amount, or % of Actual Trade Costs, and 3) Stipulated sum. Typical divisions in a large construction company are Interiors, Core, and Shell. These definitions may be changed as desired to assist managers of different construction companies to examine different aspects of their particular company. To find all job listings for a particular division, one can navigate through the division menu illustrated in FIG. 17B and described below. The information listed as the General Client Information is self explanatory. Clinking on the little triangle in the General Client Information title bar brings up the client menu illustrated in FIG. 18 and described below. A double click on the General Client Information window leads to the Client Master File Maintenance page, FIG. 12. The Client Master File Maintenance page may also be reached through the Administration “drop down” menu, or by selecting the Maintenance submenu, shown in FIG. 15.

FIG. 3 illustrates the “Base Contract Snapshot”, 6. The “Base Contract Snapshot” contains tables of data making up the Base Contract Summary table, 7, the Base Contract Markups, 8; and a General Conditions Overview Table, 9. The Base Contract Snapshot emphasizes the estimates made at the beginning of a project, and compares them to actual costs, and calculates the budget variances and profit & loss. The meanings of the particular entries shown in the Base Contract Summary Table, are as follows:

Trd Budget=Base Budget Costs

Trd Costs (Trade Costs) Sum of the Estimated Cost of the Subcontracted work to the represented trades

Variance (Budget Variance)=the negative of (Costs estimated or scheduled Value)

Trade SOV=Trade Schedule of Value (or estimate)

Markups=total Base Contract Markups, described in the next paragraph below.

Total SOV=Total Schedule of Value (or estimate)

Retained Fee=Markups minus expenses

Intrnl P/O=s=Internal construction company Purchase Orders for work which results in direct profit.

CTC=Costs to Complete

Base Contract Markups Window presents the “built-in” or anticipated profits. The Base Contract Markups includes

G/C=General conditions

Fee=Fee from markup

Ins=insurance costs related to markup

XCY=Contingency

TAX=anticipated taxes related to markup

Clicking on the small triangular toggle switch, 10, to the immediate left of the title “Base Contract Snapshot” permits the user to toggle between four (4) snapshot views, as seen in navigational chart in FIG. 14. In the version of the Job Master Summary page shown in FIG. 3A, the right-hand window displays the “Job Snapshot”, 11.

The Job Snapshot lists the same types of figures as in the Base Contract Summary, but includes the costs of the markups, producing a Job Profitability table, 12. In addition, the Job Snapshot replaces the Base Contract Markups with a Work Flow table, 13, providing a matrix listing of the number of Pending, Approved, ACA(Awaiting client Approval) and (VD)Vendor changes in C/O=s(Change Orders), Allow(Allowances), Bchgs(Budget Changes), Ctgncy (Contingency costs), and undef(undefined) or unlabeled changes in the original estimates of time and costs.

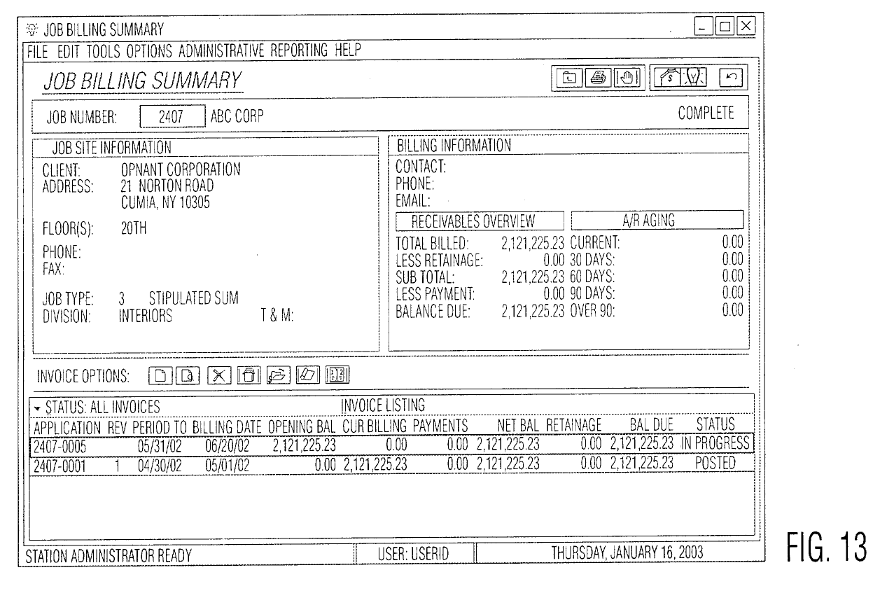

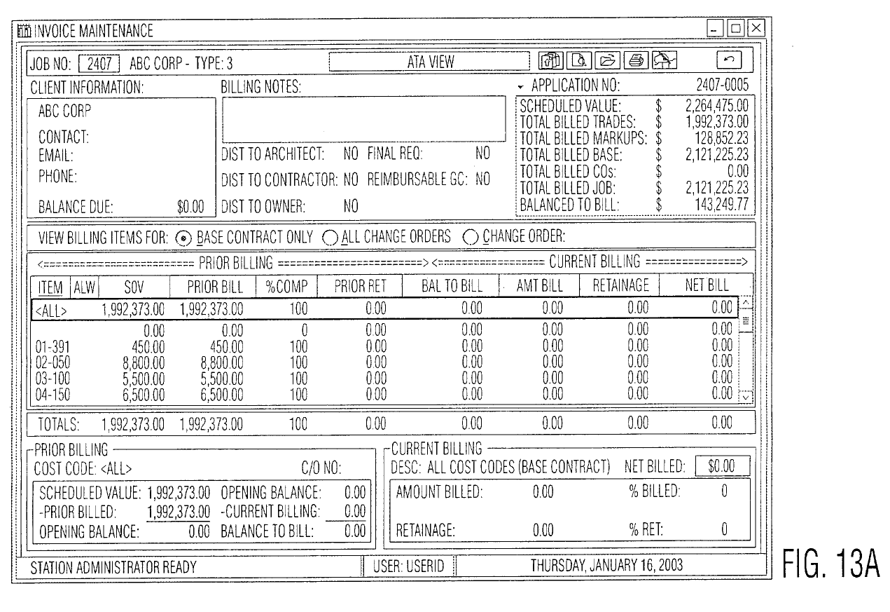

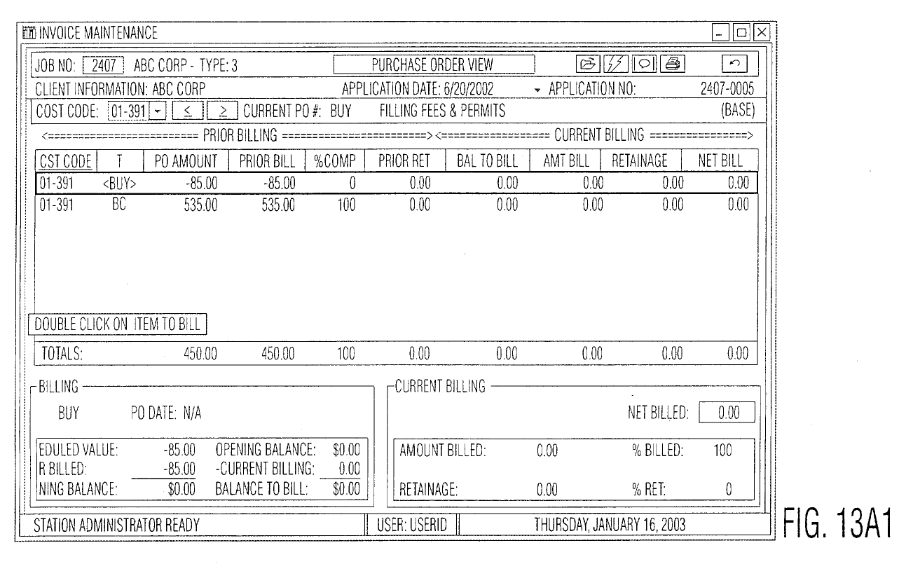

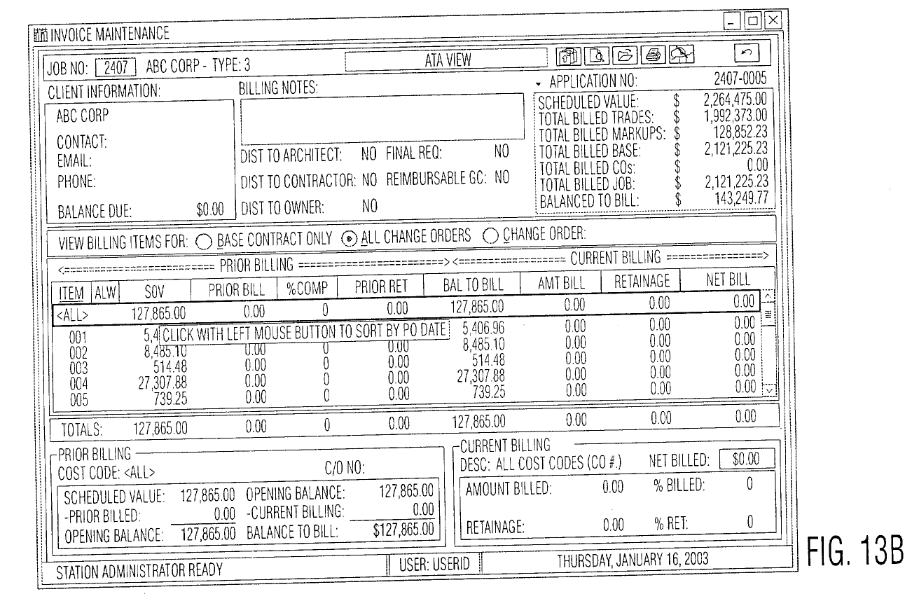

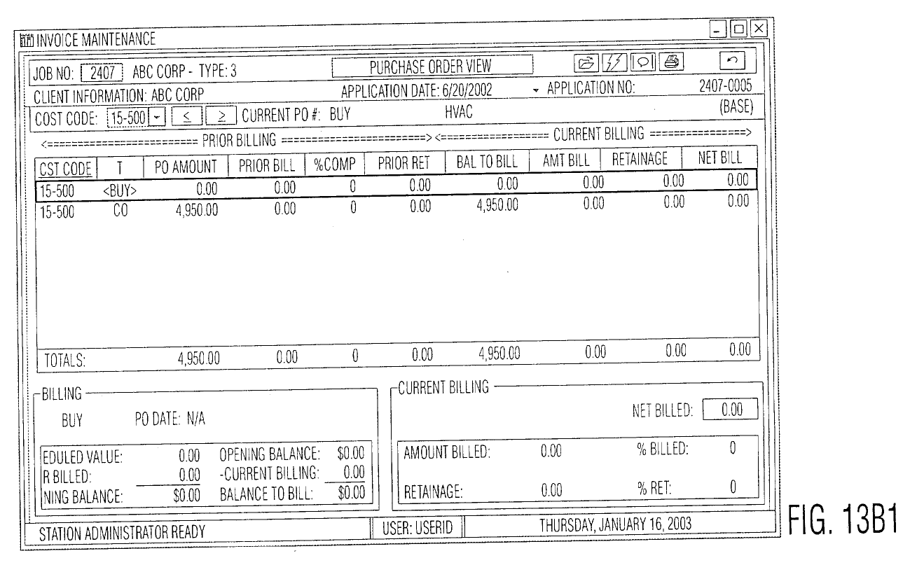

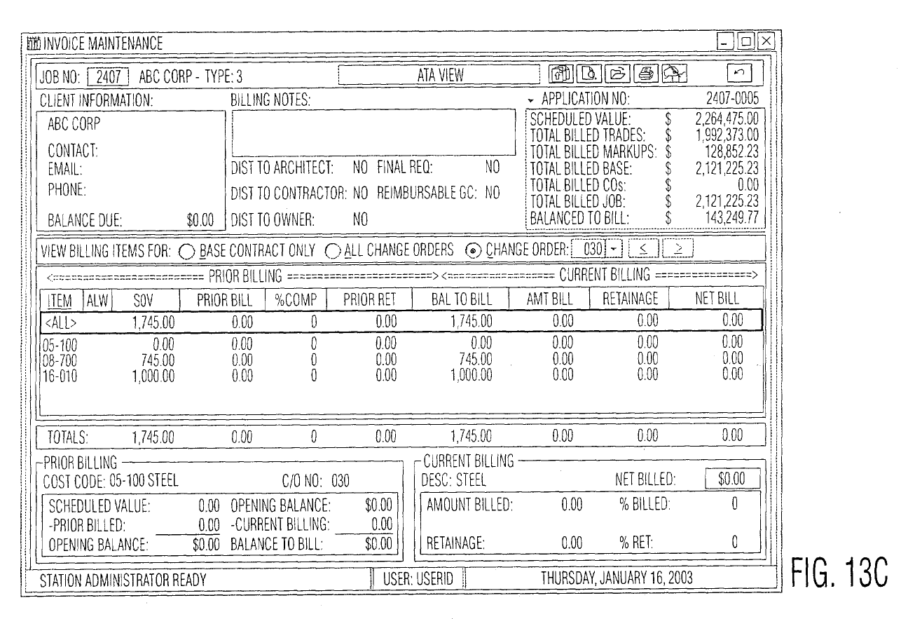

FIG. 13A1 illustrates the Job Snapshot which includes the Accounting on the job, rather than the Workflow adjustments of FIG. 13A or the Base Contract Markups of FIG. 13. Clicking on the triangle to the left of AACCOUNTING@ in the title bar, 14, can provide the Work Flow Adjustments or the Base Contract Markups, described above. In the Accounting window:

A/P Inv.=Accounts Payable Invoices

A/P Paid=Accounts Payable Invoices already paid

A/P due=Accounts Payable due

Billings=Billings to date

Cash Coll.=Cash collected to date

Retainage=moneys retained

A/R Due=Accounts Receivable due

P/R Costs—Payroll Costs

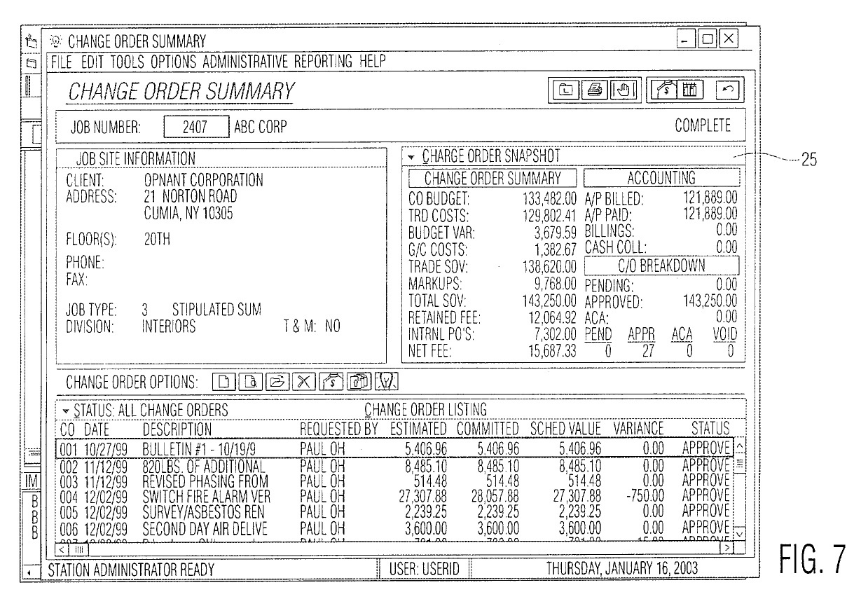

In FIG. 3B a small triangular toggle switch or menu, 19, to the immediate left of the “Change Order Snapshot” permits toggling between different views of the Change Order Snapshot. A listing of available change order snapshots may be seen in FIG. 14. The “Change Order Snapshot (ALL)”, 16, illustrated in FIG. 3B contains the same General cost Overview as the Job Snapshots, and adds a Complete Change Order Summary table, 17, and Change Order Total table, 18. The Complete Change Order Summary table contains the same analysis as the Base Contract Summary table and the Job Profitability table; calculating the variance and the profit and loss, starting from the Change Order(CO) Budget. The Complete Change Order Summary also includes the Change Order Markups, 20, similar to the Base Contract Markups, but calculated from the Change Order Budget. (The Change Order Snapshot for a particular change order will be described in relation to FIG. 7.)

The Change Order Totals table lists the dollar amount of the change orders to date, assigned to change orders pending, approved, awaiting client approval (ACA), void, and ANT(Anticipated). In addition, table sets forth the number of change orders to date in each category. The Change Orders and their approval rate provide information about the derailing of the original estimates and the ease with which the builder and client are resolving the derailment issues. The cumulative dollar amount of the change orders, in relation to the overall budget, provides information as to the threat to profitability, and the remaining ability to retain or regain profit.

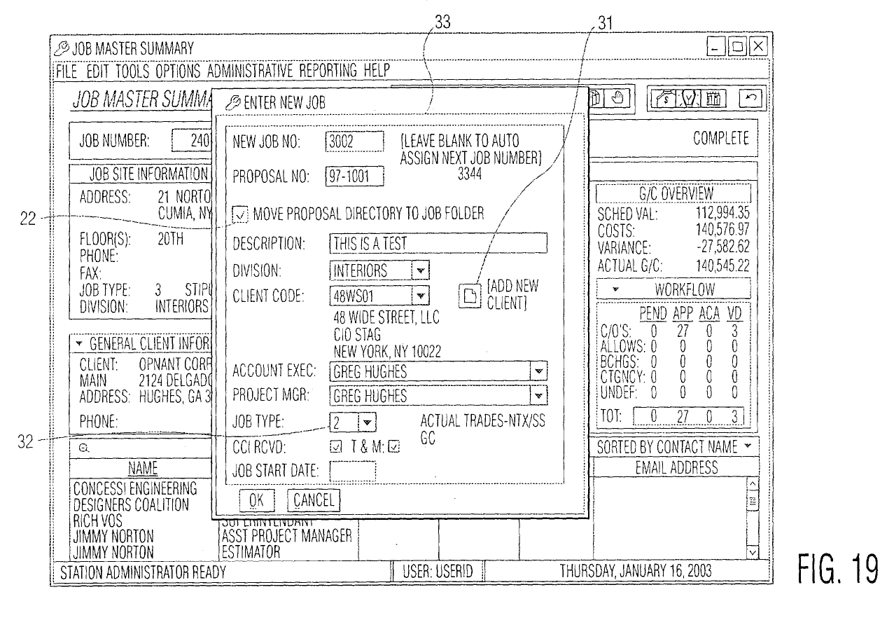

Along the top of the Job Summary page is the same horizontal menu bar. Selecting “options”, “Administrative” or “reporting” on the menu bar produces the same drop-down menus as for the Project Manager's page of FIG. 2, which menus are illustrated in the navigational chart in FIG. 15. The “file” menu may include links to data entry pages such as a “Enter New Job Screen”, 33, illustrated in FIG. 19 and described below, for entering a proposal number, and creating a proposal directory, as a new job is considered.

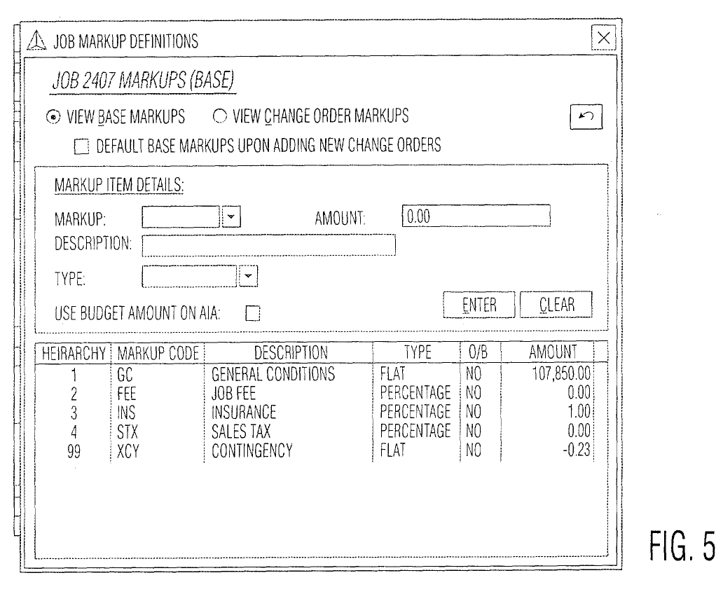

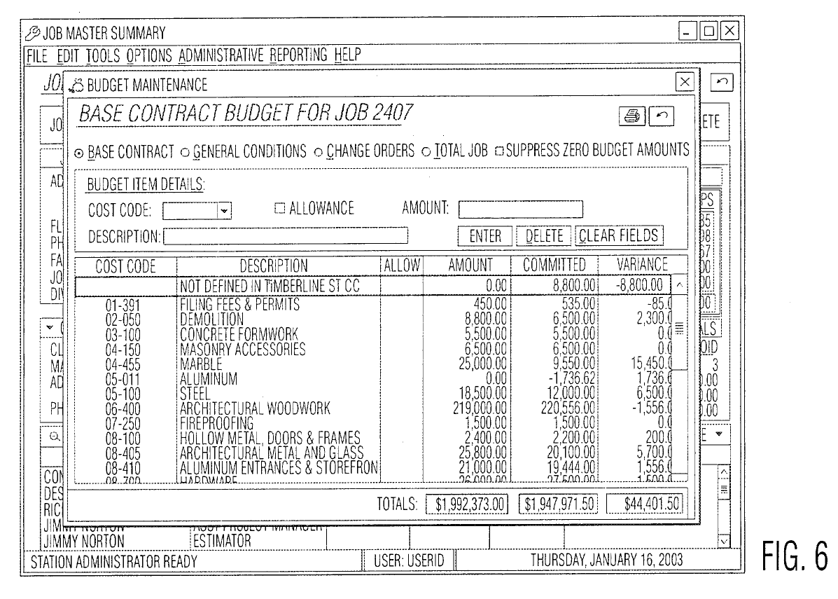

From the Job Master Summary page, data entry pages are accessible from the “Options” menu 24, of the navigation bar. Of most importance, the Options menu allows the user to access the “Job Markups” (see FIG. 5), “Budget Maintenance” (see FIG. 6) and “Change Order” (see FIG. 7), and “Billing Summary” page (see FIG. 12). As stated above, the Options menu links may be the same from the Job Change Order Summary page or Project Manager page.

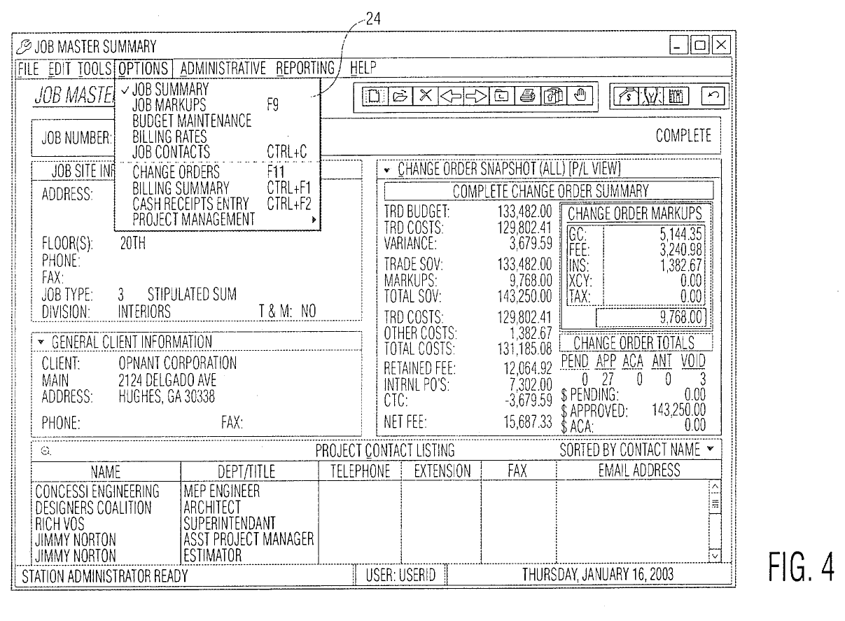

By selecting Job Markups from the Options menu of FIG. 4, the user can access a Job Markups page, such as that shown in FIG. 5. The Job Markups page is a tier three page. As shown, the Markups page offers alternate views of the Base Markups or the Change Order Markups. By selecting a particular markup in the window (using the triangular toggle switch) the data entry boxes permit entry of the dollar amount of the markup, a text description of the markup, and the type of mark up. Upon entry of this data into the boxes provided, this data may be entered into the system by, in this example, clicking on the “Enter” button. In addition, the date may be entered automatically on the Markups page upon entry of the data in a new change order. Clicking on the “Clear” button will delete the data in any highlighted box.

The markup data entered will appear in the markup summary window at the bottom of the Markups page. This window may be preprogrammed, as shown, to provide the basic categories and codes of markups, types and hierarchy's of markups. Entry of successive markups will be accumulated, or summed, in each category. After a markup is entered, the user may use the reverse arrow to return to e.g. the Job Master Summary page.

The Options menu on the navigation menu bar also contains a link to the Budget Maintenance pages, the first of which is the Base Contract Budget window shown in FIG. 6. The Base Contract Budget page is a tier three page. This window allows the user to chose between a view of the Base Contract Budget, the General Conditions Budget, the Change Orders Budget, and the Total Job Budget, all of which are tier three pages. The Base Contract Budget items are detailed in Base Contract view, shown in FIG. 6. All views of the Budget Maintenance window permit entry of data by Cost Codes, and Description and dollar Amounts, and permit viewing of the sum of each cost code budget item and the Budget total. The dollar amounts committed and the Variance for each item are also presented in this window. Referring to the Cost Codes, the number before the hyphen indicates the general category of material, e.g. 05, for metals, while the number after the hyphen specifies the precise-category, such as 05-100, for steel. The Cost codes are also used to breakout costs by Trade, as by the Steel Trade.

From the Change Orders Budget view of the Budget Maintenance pages, a particular change order may be selected, and viewed in a tier four page. The purchase orders related thereto may be selected from that page, and the details about the purchase orders viewed on a tier six page.

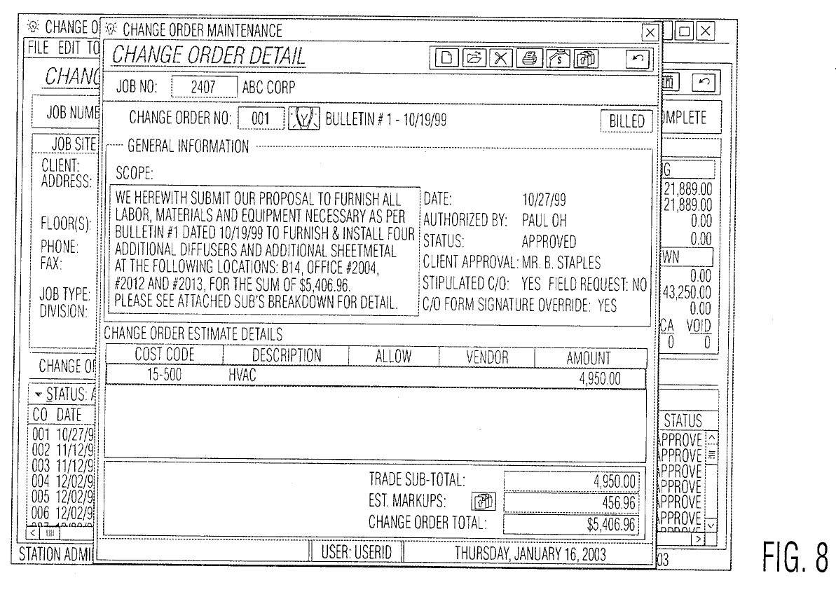

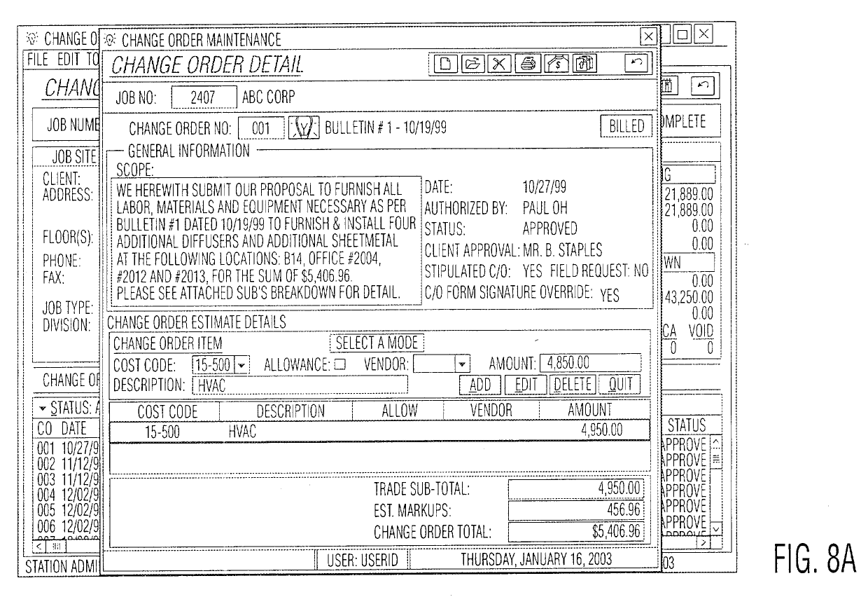

In the Options menu is also a link to a Change Order Summary page, an illustration of which is shown in FIG. 7. The Change Order Summary page is a tier three page. The Change Order Summary page has a scrolling window (here, at the bottom) for a Change Order Listing, by status. In FIG. 7, “All Change Orders” are listed. An individual change order in the list may be selected by double clicking thereon, for viewing its details, as illustrated in FIG. 8. The reverse arrow button as well as the options menu returns to the user to the Job master Summary page. Above the change order status listing is a row of “Change Order Options” buttons which present the same navigational opportunities as the like navigational buttons described in FIG. 20.

The right-hand window of the Change Order Summary page displays the “Change Order Snapshot” table, 25. The “Change Order Summary” of the Change Order Snapshot, 25, contains no sum for the Net P/L, but includes the present state of the Accounting, and the Change Order Breakdown for all of the change orders on the job. The Accounting figures- presented in this embodiment are the accounts payable billed, and paid, billings and cash collected. The Change Order Breakdown is the dollar amount of Pending, Approved, and ACA(Awaiting Client Approval) change orders, as well as a column total for the number of change orders Pending, Approved, ACA (awaiting client approval).

As stated above, the user may select a particular Change Order in the Change Order Summary, by, e.g. scrolling to the desired change order and double clicking, to bring up a Change Order Detail page, such as that depicted in FIG. 8. The Change Order Detail page is a tier four page. The Change Order Detail page presents the details of just one change order, which may include reference to the original documentation for the Change Order (“Bulletin #1—Oct. 19, 1999), the Scope of the change order, the Change Order Estimate Details in tabular form, and the details of the processing of the Change Order, seen here in the column beginning with “Date: Oct. 27, 1999”. The details, and processing particulars (billed/unbilled) may be added through the Change Order Detail page illustrated in FIG. 8A. Here, by using “select a mode”, the user may select to add, edit or delete change order estimates. FIG. 8A permits entry of cost codes, description, vendor and amount of the change order. The addition of the vendor selection permits tracking of a job (indicated by cost code, or trade) between two different vendors in the trade.

The billing portion of this system, may be reached through the Billing Summary page, FIG. 13, selected from the Options Menu (FIG. 4). The billing portion will be described in relation to FIGS. 13-13C, below. Because of the detailed, real-time figures provided to management in the other tier two pages, the Billing summary page is accessed most often by accounting personnel, who tend to move up and down the tiers beneath the Billing Summary page. The Billing portion may be tied directly to existing accounting and billing systems of the construction company, used as a stand alone system, or may be placed side-by-side with the monitoring and management system of the present invention.

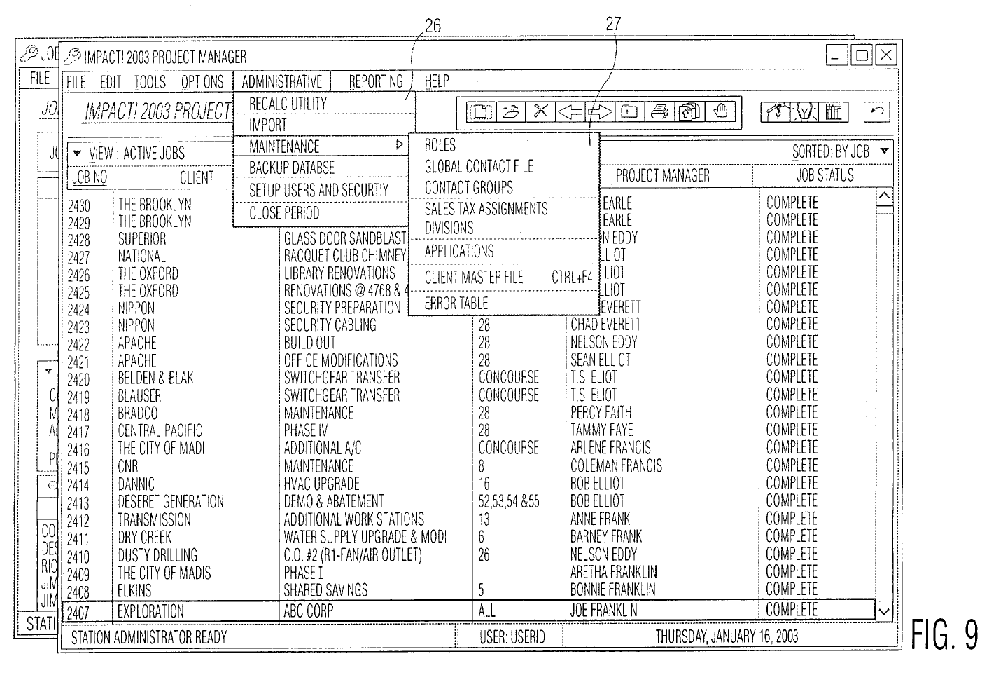

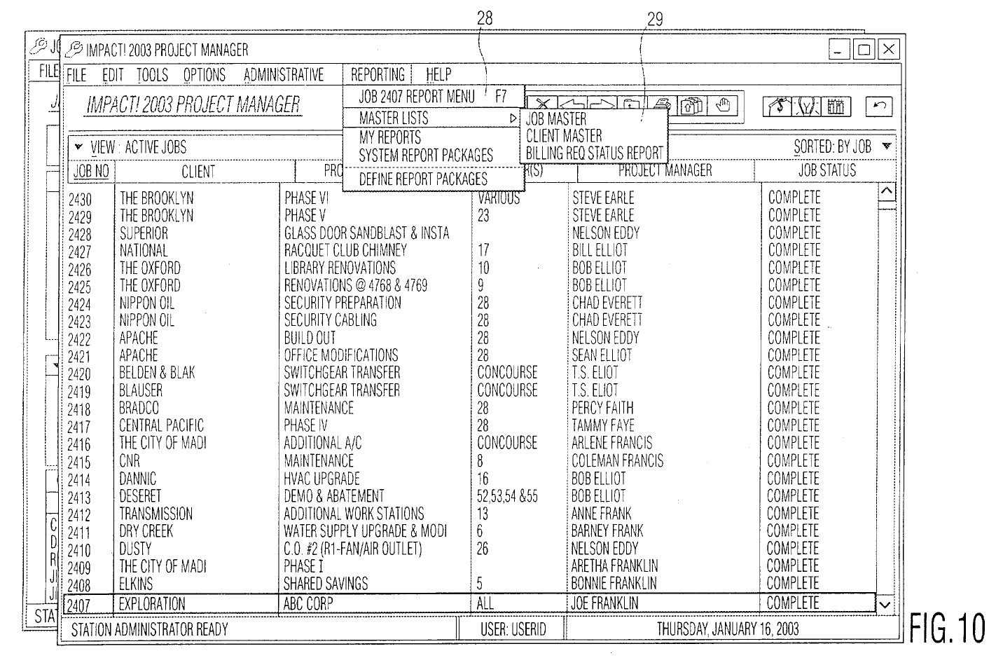

FIG. 9 illustrates an Administrative menu, 26. As illustrated, the Recalc Utility may be started from this menu, however recalculation will be automatically started by a change in job Type. Selecting Import from the Administrative menu allows the user to import data from external (perhaps side-by-side) systems. Selection of Maintenance, produces a drop-down submenu, 27, to administration detail lists of the system, including the Client Master File page.

FIG. 10 illustrates the Reporting Menu, 28. From the Project Manager page, the user may select a job, here Job 2407, for which he would like to see the Job Report Menu. Alternatively, the Job Report Menu may be obtained from the Job Summary page for Job 2407, using the Reporting menu, 28. The Reporting menu also has a Master List submenu, 29, for navigating back to the Job Master Summary page, Client Master Summary page and the Billing Request Status Report.

The Reporting menu, 28 also includes My Reports, a library, or collection, of reports a particular user accumulates for their own purposes or responsibilities; System Report Packages, leading to a selection list of the Report Packages which have been defined under the Define Report Packages selection.

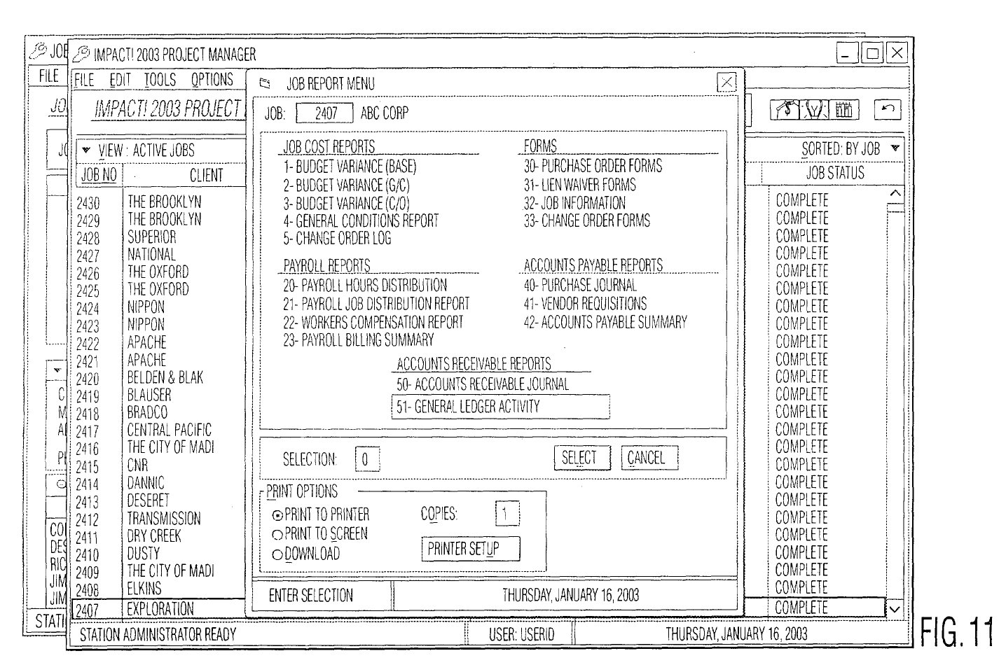

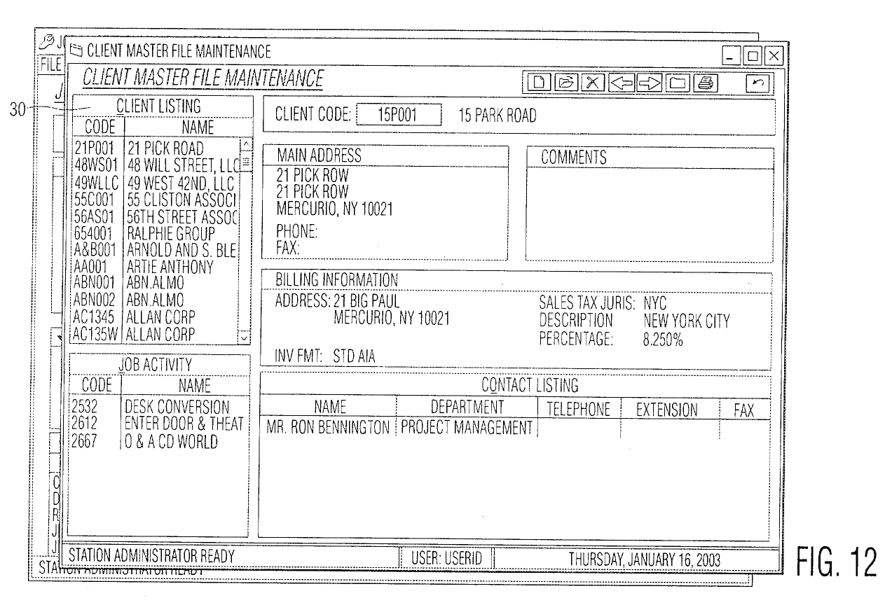

A Job Report Menu is illustrated in FIG. 11. A variety of Job Report are defined in the window as shown, and assigned a selection number. The user is provided with the option to print to screen, or printer, or to download.

FIG. 12 illustrates the Client Master File Maintenance page, which contains a client listing, 30, from which the user can see and select a given project for that client, and receive the Job Activity, Main Address of the project, Billing Information and Contact Listing.

The billing and accounting functions of the system of the present invention are shown in Job Billing Summary, illustrated in FIG. 13, and the Invoice Maintenance pages, illustrated in FIGS. 13A to 13C. The Job Billing Summary is specific as to job number. It provides a Receivables Overview, along with the A/R(Accounts Receivable) Aging. A window at the bottom of the page provides a listing of invoices by application number. For each invoice, the relevant information, such a billing date, payments, retainage, and balance due are set forth in the columns provided.

By selecting a particular invoice (here 2407-005) in the Job Billing Summary page, and, e.g., double-clicking, the user may bring up the Invoice Maintenance page for that invoice, such as that shown in FIG. 13A. Alternative views of Invoice Maintenance may be selected, as shown, between Base Contract Only (FIG. 13A), All Change Orders (FIG. 13B), and just one Change Order (FIG. 13C). FIGS. 13A, 13B, and 13C are tier four pages. They show the Invoice Maintenance of the present invention from the AIA(American Institute of Architects) view. In the AIA view, the “Application No: box sets forth the basic information concerning the SOV schedule of value), amounts billed, and balance to bill.

FIG. 13A illustrates the window in the AIA view of the Invoice Maintenance, listing all the items in base contract, by cost code. For each item, the relevant information such as SOV, prior bills, retainage, balance to bill, and net bill are set forth in the appropriate columns. By e.g. double clicking on the cost code, the user can open the purchase orders view for that cost code, FIG. 13A1, examine the current billings, double click on the item to generate a bill. The purchase orders view is a tier five page. The user may then use the back arrow to return to FIG. 13A.

In FIG. 13B the window lists the change orders in numerical order, setting forth the relevant information by application No:, such as that set forth in FIG. 13. By selecting a cost code at the bottom of the Invoice Maintenance page of FIG. 13B, the user may bring up the purchase order view of FIG. 13B1. This page is a tier five page. Billing may also be generated from this page. The navigational buttons in FIG. 13B1 include, from left to right, “open file” to edit, zoom, global update to update figures in all views, and print. Using the back arrow, the user may return to FIG. 13B.

FIG. 13C lists all the items of a particular Change Order, here, 030, setting forth the relevant Application No: information, such as in FIG. 13, and providing a listing of prior billing and current billing, set forth by cost code. Billing may also be generated from this page.

Having now reviewed the pages and menus separately, FIGS. 14, 15, and 16 show some of the navigational maps between the pages. The various users of, or participants in, the system, will be able to view, edit and navigate according to their purpose. Because so may navigational routes are provided, only a portion can be illustrated on each Figure, hence FIGS. 14, 15 and 16, must be considered together to understand the system.

FIG. 14 emphasizes access to the system details from the Job Summary page. It illustrates the Snapshots of the job that are available from the Job Master Summary page, on tier two. This information may be of most interest to the Project Manager for the particular Job. However, these Job details may also be accessed by the managers of the construction company, by selecting the job from the full Project Manager page listing, or from the Options menus of the Project Manager page or the Change Order Summary page.

FIG. 15 illustrates the navigation possibilities from the Project Manager page, emphasizing the Options, Administrative, and Reporting menus on the navigational bar of the Project Manager, Job Master Summary and Change Order Summary pages. The Figure Numbers have been added to the right of the menu entries, to assist the reader in understanding the ease of moving through the system.

The Project Manager page may be the jumping off point for the construction company managers. By clicking on the triangle at the right of the Project listing they will be able to review lists of active, completed, or pending jobs; select a Project from the Project Listing; and go immediately to its Job Summary page. Alternatively, from the triangle at the right of the Project Listing, they may select lists of jobs that are pending, and/or in progress, and go immediately to their Job Summary pages. From the Job Summary pages they may easily survey the basic information about the ongoing project from the selection of Snapshots, or various tier three pages available in the Options “drop down” menu. The administration of the project is laid out in Administrative menu, and reports defined and provided from the Reports me. The alternative views of the Project Listing at the bottom of the Project Manager page are described in relation to FIGS. 17A and 17B, below.

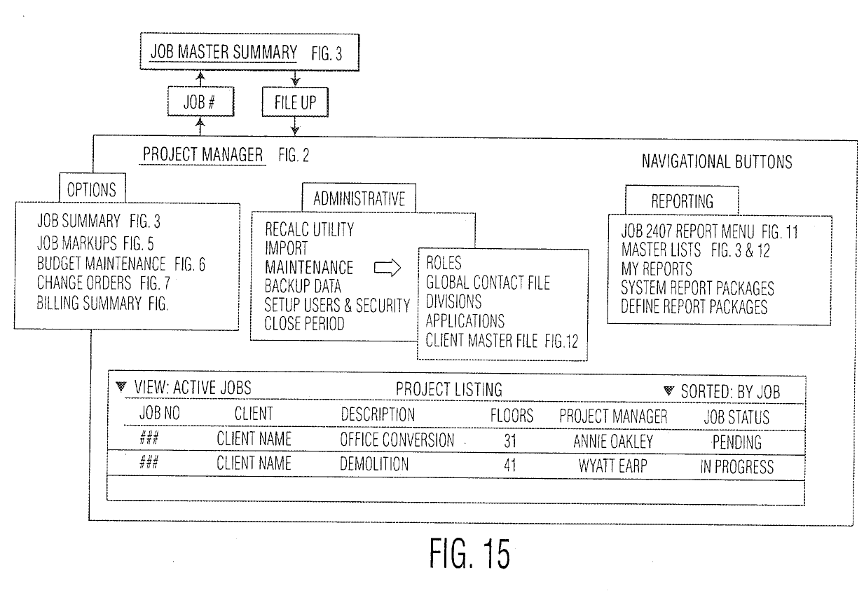

Navigation from the Change Order Summary page, illustrated in FIG. 16, allows one to review the job by its change order listing, selecting a particular Change order (by C/O #) and e.g. double-clicking, to view greater detail. Because the Change Order Summary page is a tier three page, the user must go to e.g. the Job Master Summary (by the options menu or “file up”), and “file up” to the Project Manager page. The Change Order Summary lists the difficulties encountered on the job, and provides access to details for each. This information may be used by the Project Manager to track his/her progress; and by the construction company managers to locate difficult trends in negotiate new change orders, as, for example relating to a particular cost code, or trade, to assist all project managers in finding a way to negotiate these change orders, and in changing the way they estimate new Trade Budgets.

FIGS. 17A and 17B illustrate the navigational menus for the Project Managers, enabling them to check the status of all jobs at a particular phase of completion, through the status menu of the Project Manager page; and the jobs been worked by the different divisions, though the Division menu of the Project Manager page.

FIG. 18 illustrates the Client menu reached through the Job Master Summary, from which one can obtain client information, such as billing and payment of client, and a Master File Maintenance, showing all work being done for that client.

FIG. 19 illustrates the window, 33, for entering a new job. As the job is undertaken, the system provides means, such as at 22, for moving the information from the proposal directory into the Job Folder, which is used by the system to produce the Project Manager and Job Master Summary lists. The “Add New Client window”, 31, used to compile the Client Master file list, and generate client views and information windows. The Job Type window 32 permits designation of Job Type, which will determine the method of creating, and updating the budget figures, and billing the job. When the new job is added, by adding it to the job folder, the “Job Master Summary” page, and a “Base Contract Markup” page for the new job fly up onto the screen, prompting the user to begin entering data on this job.

FIG. 20 illustrates the full button navigation available from the Project Manager or Job Summary pages. The buttons, labeled a-1, present navigational opportunities as follows:

a=new job entry window (FIG. 19)

b=update job details on Job Master Summary page

c=delete highlighted data

d=go back to previous job

e=go back forward one job

f=file up, go up a rank, e.g. from Job Master Summary to Project Manager

g=list the Reports that may be printed

h=go to Markups (FIG. 5)

i=go to Budget Maintenance

j=go to Change Order Summary (FIG. 7)

k=import

1=go back one job

m=billing summary (FIG. 13)

Shortened rows of buttons appear in other pages of the system, but in each instance the individual buttons retain their meaning.

There has thus been shown and described a novel system for the monitoring and management of construction projects and businesses which fulfills all the objects and advantages sought therefor. Many changes, modifications, variations and other uses and applications of the subject invention will, however, become apparent to those skilled in the art after considering this specification and the accompanying drawings which disclose the preferred embodiments thereof.

All such changes, modifications, variations and other uses and applications which do not depart from the spirit and scope of the invention are deemed to be covered by the invention, which is to be limited only by the claims which follow.

I claim:

1. A System for real-time monitoring and cost management a Construction Project, the system comprising:
a) data entry of time estimates and budget estimates selected from the group consisting of: proposal costs, trade budgets, trade schedules of value, base contract markups, job budgets, general conditions budgets, proposed change orders, change orders and change order budgets, change order markups, internal purchase orders, and
b) real-time data entry of costs incurred, selected from the group consisting of: trade costs, including back charges and allowances, general conditions costs, and contingency costs, and
c) real-time calculation of variations in budget and time estimates, and
d) real-time generation of the proposed change orders to reflect variations in time estimates and/or budget estimates.

2. The monitoring and management System of claim 1, wherein the system can accept and post proposed change order approval signals generated from multiple electronic devices, from various geographical locations, through diverse communication systems.

3. The monitoring and management System of claim 1 wherein the system is an electronic system, on an electronic network.

4. The monitoring and management System of claim 3, wherein the network is an internet website.

5. The monitoring and management System of claim 4, further comprising data entry of the contact information for the real-time communication with the individuals responsible for approving change orders, and wherein the system further comprises the communication of the proposed change order reflecting the variations in budget or time estimates to the individuals who must approve the change order.

6. The monitoring and management System of claim 5, wherein the system further comprises security clearance levels for data entry, data viewing, receipt of proposed change orders, and possible cost and/or schedule reports, and the acceptance of change orders.

7. A method for real-time monitoring and cost management of multiple construction projects of a construction business, comprising the System of claim 1, wherein the data entry, calculation of budget and time estimate variances and proposed change orders, and calculation and posting of cost impact and schedule impact statements for the multiple projects may be easily assembled and viewed by the project manager, and accessed by the client.

8. A method for real-time monitoring and cost management of multiple construction projects of a construction business organized by division, comprising the System of claim 1, wherein the data entry, calculation and posting of budget variances, and automatic calculation and posting of cost impact and time schedule impact statements for the multiple projects may be accessed by division.

9. The monitoring and management System of claim 5, wherein the individuals responsible for approving change order comprises the architect and project manager.

10. The monitoring and management System of claim 9, wherein the individuals further comprises a trade representative.

11. The monitoring and management System of claim 9 wherein the individuals further comprises a client representative.

12. The monitoring and management System of claim 3 wherein the electronic system comprises a computer network server.

13. The monitoring and management System of claim 1, wherein the possible cost impact and/or time schedule impact of proposed change orders is automatically communicated to individuals responsible for approving the change orders, by e-mail to hand-held electronic devices.

14. The monitoring and management System of claim 1, wherein the possible cost impact and/or time schedule impact of proposed change orders is automatically communicated to individuals responsible for approving the change orders, by cell phone messaging.

15. The monitoring and management System of claim 1, further comprising the real-time calculation and posting of accounts receivable reports and billing statements.

16. The monitoring and management System of claim 15, further comprising the generation of billing statements.

17. The monitoring and management System of claim 15, further comprising the generation and posting of the progress of billing a construction project.

18. The monitoring and management System of claim 16, further comprising the generation and posting of the progress of collection of the accounts receivable.

19. The monitoring and management System of claim 15, further comprising the generation and posting of the profitability of multiple construction projects.
